(19) United States
(12) Patent Application Publication
(10) Pub. No.: US 2009/0022371 A1
(43) Pub. Date: Jan. 22, 2009

(54) MOVEMENT DETECTION METHOD AND DEVICE WITH ADAPTIVE DOUBLE FILTERING

(75) Inventor: Arnaud VERDANT, La Tour De Pin (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 12/172,460

(22) Filed: Jul. 14, 2008

(30) Foreign Application Priority Data
Jul. 16, 2007 (FR) 07 56519

(51) Int. Cl. G06K 9/00

(52) U.S. Cl. 382/107

(57) ABSTRACT

Movement detection method comprising the following steps:
the calculation of a first mean M1ₙ of a signal Sₙ designed to be supplied by one pixel of a pixel matrix which corresponds to an n-th captured image, in function of the value of the signal Sₙ and/or a previous value M1ₙ₋₁;
the calculation of a second mean M2ₙ of the signal Sₙ in function of a previous value M2ₙ₋₁ and/or the value of the signal Sₙ;
the calculation of a signal Δₙ=|M1ₙ−M2ₙ|;
the calculation of a third mean M3ₙ of the signal Δₙ or k. Δₙ in function of a previous value M3ₙ₋₁ and/or the value of the signal Δₙ;
the comparison of the signals Δₙ and k.M3ₙ or Δₙ and M3ₙ, wherein a movement is considered as detected when Δₙ>k.M3ₙ or Δₙ>M3ₙ.

### TECHNICAL FIELD

This document relates to the field of movement detection and more particularly that of image sensors, such as CMOS imaging devices used in the visible or infrared range, wherein a movement detection method is used.

### STATE OF THE PRIOR ART

Movement detection involves detecting the movement of moving elements with respect to fixed elements in a field of captured images. These elements may be for example vehicles or even people. Such movement detection consists of isolating, among the signals supplied by an image sensor, those related to the moving elements, for example by detecting the significant variations on the mean or variance of a signal of a pixel or a group of pixels indicating a change in the nature of the element captured in this pixel or group of pixels, with respect to those related to the fixed elements of which the mean or variance remains for example substantially constant in time. For this purpose, detection methods or algorithms are used.

A first approach consists of using a “recursive average” algorithm for such movement detection. This algorithm is based on an estimated background calculation, which is to say of the fixed elements found in all of the captured images. Which is to say Xₙ is the background, or the mean, corresponding to an image n, Sₙ is the signal corresponding to the acquired image n and 1/N is a weighting coefficient, therefore:

$${X}_{n} = {X}_{n - 1} - \frac{1}{N} {X}_{n - 1} + \frac{1}{N} {S}_{n}$$

A comparison is then made between a chosen threshold value Tₕ and |Sₙ−Xₙ|. If the value obtained is positive, this means that a movement has been detected. Xₙ and Sₙ may be variables obtained from a signal supplied by a pixel or by considering several signals supplied by several pixels, for example a group of pixels located next to one another that form a macropixel, like a single signal, taking for example the mean of these signals.

Such an algorithm has especially as disadvantage a lack of robustness in the detection as the detection threshold Tₕ is determined à priori, prior to the algorithm being used, and is global for all of the pixels of the matrix. This disadvantage results in low precision of the location of the movements in the captured images. The low pass type filtering carried out by this algorithm induces dephasing, and consequently a delay in the response with respect to the signal. This delay results in a drag effect which occurs downstream of the passage of a moving element.

A second approach consists of using a “sigma-delta” algorithm for the movement detection. This algorithm permits significant variations of the signal to be detected by calculating two variables that can be assimilated to the mean value and the variance of the signal. FIG. 1 is a diagrammatical representation of a movement detection device using a sigma-delta algorithm.

Firstly, the sigma-delta mean M1ₙ is calculated, with a constant incrementation and decrementation value, for example 1, of the signal Sₙ corresponding to the acquired image n. For this purpose, the signal Sₙ is sent as an input of the first means of calculating the sigma-delta mean 2. These means 2 first carry out an initialisation M1₀=S₀. For the following images, which is to say for n>0, these means 2 compare M1ₙ₋₁ and Sₙ. If M1ₙ₋₁<Sₙ, then the value of M1ₙ₋₁ is incremented such that M1ₙ=M1ₙ₋₁+1. If M1ₙ₋₁>Sₙ, then the value of M1ₙ₋₁ is decremented such that M1ₙ=M1ₙ₋₁. The value of the signal Δₙ=|M1ₙ−Sₙ| is calculated by a subtractor 4 and absolute value calculation means 6. The calculation of N×Δₙ is then made by the multiplier 8, wherein N is a constant corresponding to the adaptive threshold of the algorithm whose value is chosen in function of the complexity of the scene. The calculation of a sigma-delta mean M2ₙ of N.Δₙ is then made and sent as an input of second means of calculating the sigma-delta mean 10. Next, the initialisation M2₀=0 is carried out first. For the following images, which is to say for n>0, a comparison is made of M2ₙ₋₁ and N.Δₙ. If M2ₙ₋₁<N.Δₙ, then the value of M2ₙ₋₁ is incremented such that M2ₙ=M2ₙ₋₁+1. If M2ₙ₋₁>N.Δₙ, then the value of M2ₙ₋₁ is decremented such that M2ₙ=M2ₙ₋₁−1. Finally, a comparison is made by a comparator 12 of the signal Δₙ and M2ₙ. If M2ₙ<Δₙ, this means that a movement has been detected.

As for the recursive average algorithm, the variables Sₙ, M1ₙ, Δₙ and M2ₙ may be obtained from a signal supplied by a pixel or by considering several signals supplied by several pixels, for example a group of pixels next to one another, like a single signal, taking for example the mean of these signals.

However, such an algorithm especially has the disadvantage of not filtering high frequency parasite movements which are considered as movements to be detected (for example, a movement of the leaves of a tree or snow falling). Furthermore, the constant N used must be determined à priori, which reduces the adaptability of the detection carried out by this algorithm.

### DESCRIPTION OF THE INVENTION

Thus there is a need to propose a method of movement detection which permits the detection of high frequency parasite movements to be reduced or eliminated and which offers more efficient detection, for example in terms of precision of locating the movements, with respect to the methods of the prior art, and which reduces or eliminates the “drag” effect obtained by the methods of the prior art.

Also, there is a need to propose a method of movement detection which requires few calculation and memory hardware resources to be used, and that can be installed analogically in a very low consumption imaging device (with for example a mean consumption equal to approximately several hundred μW).

For this purpose, one embodiment proposes a method of movement detection comprising at least the following steps:
the calculation of a first mean M1ₙ of a signal Sₙ designed to be supplied by at least one pixel of a pixel matrix which corresponds to an n-th captured image, in function of the value of the signal Sₙ and/or a previous value M1ₙ₋₁;
the calculation of a second mean M2ₙ of the signal Sₙ in function of a previous value M2ₙ₋₁ and/or the value of the signal Sₙ;
the calculation of a signal Δₙ=|M1ₙ−M2ₙ|;
the calculation of a third mean M3ₙ of the signal Δₙ or k.Δₙ in function of a previous value M3ₙ₋₁ and/or the value of the signal Δₙ;
the comparison of the signals Δₙ and k.M3ₙ when M3ₙ is the third mean of the signal Δₙ, wherein a movement is considered as detected when Δₙ>k.M3ₙ, or the comparison of the signals Δₙ and M3ₙ when M3ₙ is the third mean of the signal k.Δₙ, wherein a movement is considered as detected when Δₙ>M3ₙ;

where k: non-null positive real number, and

n: natural whole number.

Using adaptive double filtering, by adaptive calculation of two means, one designed to estimate the background and the other to detect the variations in the captured images, band pass filtering may be generated to eliminate the high frequency parasite movements, for example snow falling, which constitute a noise and thus movements that are not to be detected. This pass band filtering also enables to delete statistical backgrounds. The calculation of the difference of the two means M1ₙ and M2ₙ enables to only consider the objects which have a speed of movement comprised between these two means.

The adaptability of the detection is also improved by eliminating certain constants that had to determined à priori in the methods of the prior art. The sensitivity of the detection is also adapted locally to the activity of the pixels, which is to say individually for each pixel.

The second mean M2ₙ may be obtained from the following equation:

$$M {2}_{n} = M {2}_{n - 1} - \frac{1}{{N}_{2}} M {2}_{n - 1} + \frac{1}{{N}_{2}} {S}_{n} ,$$

where M2₋₁=0, and

1/N₂: non-null positive real number.

By choosing an appropriate value of 1/N₂, the time constant of the calculation of this second mean may be chosen, which may be rapid to detect the variations recorded during the movement detection.

The first mean M1ₙ may be obtained from the following equation:

$$M {1}_{n} = M {1}_{n - 1} - \frac{1}{{N}_{1}} M {1}_{n - 1} + \frac{1}{{N}_{1}} {S}_{n} ,$$

where M1₋₁=0, and

1/N₁: non-null positive real number.

Analogously to the choice of the value of 1/N₂, the choice of the value of 1/N₁ may determine the time constant of the calculation of this first mean, which may be slow to estimate the background of the captured images.

In one variant, the first mean M1ₙ may be obtained at least by the following calculation steps:

M1₀=S₀;

And for n>0:

M1ₙ=M1ₙ₋₁+c₁ when M1ₙ₋₁<Sₙ;

M1ₙ=M1ₙ₋₁−c₁ when M1ₙ₋₁>Sₙ;

where c₁: non-null positive real number.

The value of the first mean M1ₙ may be greater than a first non-null minimum threshold value S_{M1n}.

The value of the second mean M2ₙ may be greater than a second non-null minimum threshold value S_{M2n}.

When M3ₙ is the third mean of the signal Δₙ, M3ₙ may be obtained from the following equation:

$$M {3}_{n} = M {3}_{n - 1} - \frac{1}{{N}_{3}} M {3}_{n - 1} + \frac{1}{{N}_{3}} {Δ}_{n} ,$$

where M3₋₁=0, and

1/N₃: non-null positive real number.

When M3ₙ is the third mean of the signal k.Δₙ, M3ₙ may be obtained from the following equation:

$$M {3}_{n} = M {3}_{n - 1} - \frac{1}{{N}_{3}} M {3}_{n - 1} + \frac{1}{{N}_{3}} k \cdot {Δ}_{n} ,$$

where M3₋₁=0, and

1/N₃: non-null positive real number.

In one variant, when M3ₙ is the third mean of the signal Δₙ, M3ₙ may be obtained at least by the following calculation steps:

M3₀=Δ₀;

And for n>0:

M3ₙ=M3ₙ₋₁+c₃ when M3ₙ₋₁<Δₙ;

M3ₙ=M3ₙ₋₁−c₃ when M3ₙ₋₁>Δₙ;

where c₃: non-null positive real number.

When M3ₙ is the third mean of the signal k.Δₙ, M3ₙ may be obtained at least by the following calculation steps:

M3₀=k.Δ₀;

And for n>0:

M3ₙ=M3ₙ₋₁+c₃ when M3ₙ₋₁<k.Δₙ;

M3ₙ=M3ₙ₋₁−c₃ when M3ₙ₋₁>k.Δₙ;

where c₃: non-null positive real number.

The value of the third mean M3ₙ may be greater than a third non-null minimum threshold value S_{M3n}.

The values of S_{M1n} and/or S_{M2n} and/or S_{M3n} may be comprised between approximately 1/250×the dynamic of the signal Sₙ and 1/25×the dynamic of the signal Sₙ, and for example equal to approximately 1/50×the dynamic of the signal Sₙ, the dynamic of the signal Sₙ corresponding to the possible maximum value of |Sₙ| (for example equal to 256 for a 8 bits coded signal).

The value of k may be between approximately 1.2 and 4.

The values of the weighting coefficients 1−N, as well as the values of the incrementation and decrementation coefficients c in the case of a sigma-delta type mean calculation, may be calculated in function of the speed of acquisition of the images, and may be easily determined. The time constant τ of a mean may be equal to the ratio: sampling period of the image capture/ln(1−1/N)⁻¹, the sampling period corresponding to the period of the signal Sₙ period (noted period(Sₙ)).

The values of the weighting coefficients 1/N which may be used for the calculation of means M1ₙ and/or M2ₙ and/or M3ₙ may be chosen such that the time constant τ of the first mean M1ₙ is short, that is lower than about 0.5 second (for example equal to 380 ms), and that the time constants τ of means M2ₙ and/or M3ₙ are long, that is greater than about 1 second (for example equals to 1.18 s), at a sampling period equal to 25 Hz.

The values of the incrementation and decrementation coefficients c which may be used for the calculation of means M1ₙ and/or M3ₙ may be chosen and adapted during the method in order to satisfy the relation c<|dSₙ/dn|. In one variant, when the incrementation and decrementation coefficients have fixed values, for example equal to 1, it is possible to adapt a refresh period Tn of the method, that is the period of which the steps of the method are realized, in order to satisfy the relation c<|ΔSₙ/Tn|.

The values of 1/N₁ and/or 1/N₂ and/or 1/N₃ may be chosen such that:

période(Sₙ)/ln(1−1/N₁)⁻¹<0.5 s;

période(Sₙ)/ln(1−1/N₂)⁻¹>1 s;

période(Sₙ)/ln(1−1/N₃)⁻¹>1 s;

and/or the values of c₁ and/or c₃ may verify the relation: c<|dSₙ/dn|.

The calculation of the third mean M3ₙ may be realized when Δₙ has a non-null value.

Another embodiment also relates to a movement detection device comprising at least:
means of calculating, or a calculator of, a first mean M1ₙ of a signal Sₙ designed to be supplied by at least one pixel of a pixel matrix and corresponding to an n-th captured image, in function of the value of the signal Sₙ and/or a previous value M1ₙ₋₁;
means of calculating, or a calculator of, a second mean M2ₙ of the signal Sₙ in function of a previous value M2ₙ₋₁ and/or the value of the signal Sₙ;
means of calculating, or a calculator of, a signal Δₙ=|M1ₙ−M2ₙ|;
means of calculating, or a calculator of, a third mean M3ₙ of the signal Δₙ or k.Δₙ, in function of a previous values M3ₙ₋₁ and/or the value of the signal Δₙ;
means of comparing, or a comparator of, the signals Δₙ and k.M3ₙ when M3ₙ is the third mean of the signal Δₙ, wherein a movement is considered as detected when Δₙ>k.M3ₙ, or means of comparing, or a comparator of, the signals Δₙ and M3ₙ when M3ₙ is the third mean of the signal k.Δₙ, wherein a movement is considered as detected when Δₙ>M3ₙ;

where k: non-null positive real number, and

n: natural whole number.

The means of calculating, or the calculator of, the second mean M2ₙ may carry out at least the following operation:

$$M {2}_{n} = M {2}_{n - 1} - \frac{1}{{N}_{2}} M {2}_{n - 1} + \frac{1}{{N}_{2}} {S}_{n} ,$$

where M2₋₁=0, and

1/N₂: non-null positive real number.

The means of calculating, or the calculator of, the second mean M2ₙ may comprise at least two switched capacities connected in parallel to one another, wherein a first of the two capacities comprises a capacity

$${C}_{1} = \frac{{N}_{2} - 1}{{N}_{2}}$$

and a second comprises a capacity

$${C}_{2} = \frac{1}{{N}_{2}} ,$$

where 1/N₂: non-null positive real number.

The means of calculating, or the calculator of, the first mean M1ₙ may carry out at least the following operation:

$$M {1}_{n} = M {1}_{n - 1} - \frac{1}{{N}_{1}} M {1}_{n - 1} + \frac{1}{{N}_{1}} {S}_{n} ,$$

where M1₋₁=0, and

1/N₁: non-null positive real number.

The means of calculating, or the calculator of, the first mean M1ₙ may comprise at least two switched capacities connected in parallel to one another, wherein a first of the two capacities comprises a capacity

$${C}_{3} = \frac{{N}_{1} - 1}{{N}_{1}}$$

and a second comprises a capacity

$${C}_{4} = \frac{1}{{N}_{1}} ,$$

where 1/N₁: non-null positive real number.

In one variant, the means of calculating, or the calculator of, the first mean M1ₙ may comprise at least:
means of initialising the value of M1₀ to the value of S₀;
means of comparing, or a comparator of, the value of the signal M1ₙ₋₁ and the value of the signal Sₙ;
means of incrementing and decrementing the value of M1ₙ by a constant c₁, where c₁: non-null positive real number.

When M3ₙ is the third mean of the signal Δₙ, the means of calculating, or the calculator of, the third mean M3ₙ may carry out at least the following operation:

$$M {3}_{n} = M {3}_{n - 1} - \frac{1}{{N}_{3}} M {3}_{n - 1} + \frac{1}{{N}_{3}} {Δ}_{n} ,$$

where M3₋₁=0, and

1/N₃: non-null positive real number.

When M3ₙ is the third mean of the signal

k.Δₙ, the means of calculating, or the calculator of, the third mean M3ₙ may carry out at least the following operation:

$$M {3}_{n} = M {3}_{n - 1} - \frac{1}{{N}_{3}} M {3}_{n - 1} + \frac{1}{{N}_{3}} k \cdot {Δ}_{n} ,$$

where M3₋₁=0, and

1/N₃: non-null positive real number.

The means of calculating, or the calculator of, the third mean M3ₙ may comprise at least two switched capacities connected in parallel to one another, wherein a first of the two capacities comprises a capacity

$${C}_{5} = \frac{{N}_{3} - 1}{{N}_{3}}$$

and a second comprises a capacity

$${C}_{6} = \frac{1}{{N}_{3}} ,$$

where 1/N₃: non-null positive real number.

In one variant, when M3ₙ is the third mean of the signal Δₙ, means of calculating, or the calculator of, the third mean M3ₙ may comprise at least:
means of initialising the value of M3₀ to the value of Δ₀;
means of comparing the value of the signal M3ₙ₋₁ and the value of the signal Δₙ;
means of incrementing and decrementing the value of M3ₙ by a constant c₃, where c₃: non-null positive real number.

When M3ₙ is the third mean of the signal k.Δₙ, means of calculating, or the calculator of, the third mean M3ₙ may comprise at least:
means of initialising the value of M3₀ to the value of k.Δ₀;
means of comparing the value of the signal M3ₙ₋₁ and the value of the signal k.Δₙ;
means of incrementing and decrementing the value of M3ₙ by a constant c₃, where c₃: non-null positive real number.

The means of comparison may comprise at least one operational amplifier, or transconductance amplifier.

Finally, another embodiment also relates to an image capture device comprising at least one pixel matrix and one movement detection device as previously described.

### BRIEF DESCRIPTION OF THE DRAWINGS

This invention will be more clearly understood upon reading the following description of embodiments provided purely by way of illustration and in no way restrictively, in reference to the appended drawings in which:

FIG. 1 shows diagrammatically a sigma-delta algorithm movement detection device,

FIG. 2 shows diagrammatically a double adaptive filtering movement detection device,

FIG. 3 shows signals obtained during the implantation of a double adaptive filtering movement detection method,

FIG. 4 shows images of movements detected obtained by a sigma-delta algorithm movement detection method and by a double adaptive filtering movement detection method,

FIG. 5 shows part of an image capture device comprising an example of a double adaptive filtering movement detection device.

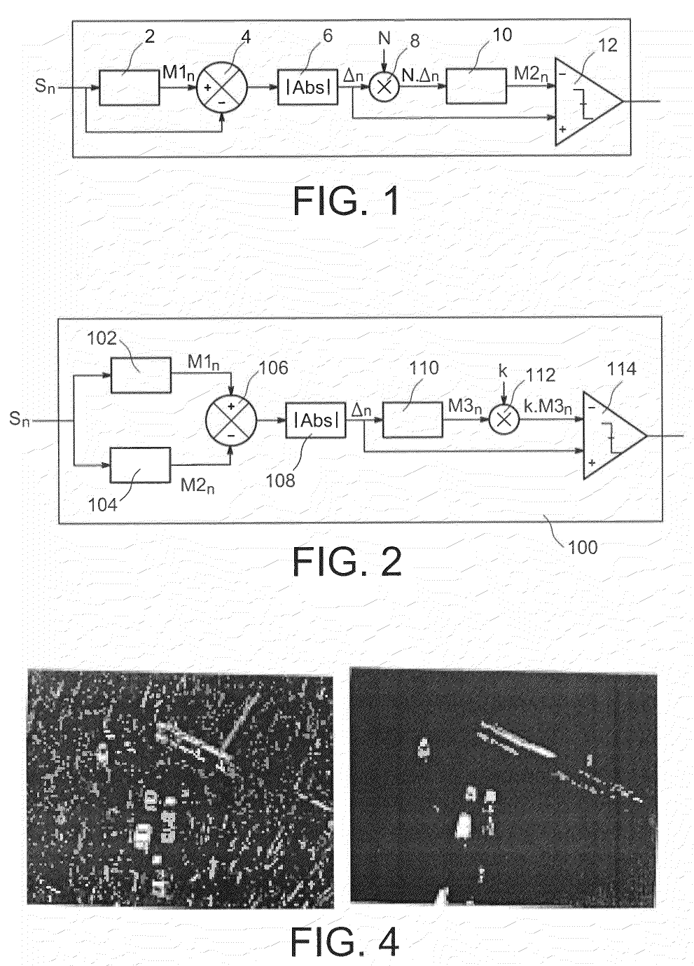

Identical, similar or equivalent parts of the various figures described below have the same numerical references so as to facilitate the passage from one figure to another.

The different parts shown in the figures are not necessarily to a uniform scale, to make the figures easier to read.

The different possibilities (variants and embodiments) should be understood as not being mutually exclusive and may be combined with one another.

### DETAILED DESCRIPTION OF SPECIFIC EMBODIMENTS

A double adaptive filtering movement detection device 100 and method, using a RAE algorithm (“Recursive average and Estimator”), according to one specific embodiment will now be described in relation to FIG. 2.

A first step of this method is to estimate the background of the images in which a movement is to be detected, wherein the background is formed by the fixed elements in the captured images. For this purpose, firstly, using means 102, a first recursive average M1ₙ is calculated wherein an important weighting coefficient 1/N₁ of a signal Sₙ corresponding to the signal supplied by a pixel, or a group of pixels also called macropixel, of an n-th acquired image. Wherein:

$$M {1}_{n} = M {1}_{n - 1} - \frac{1}{{N}_{1}} M {1}_{n - 1} + \frac{1}{{N}_{1}} {S}_{n}$$

In this calculation of the first mean M1ₙ, the choice of the value of the weighting coefficient 1/N₁ is important so that only the fixed elements in the acquired images are conserved. For an image capture device operating at 25 Hz, for example a weighting coefficient such as N₁=2⁴ is chosen. The value of the weighting coefficient 1/N₁ is chosen in function of the amplitude and the frequency of the variations of the signal Sₙ.

Consequently, the value M1ₙ calculated for a pixel or a macropixel corresponds to the luminous intensity emitted by the fixed element captured by this pixel or this macropixel, even if one or several moving elements temporarily pass before this pixel or this macropixel during the movement detection.

In one variant of this embodiment, the first mean M1ₙ may not be a recursive average, but a sigma-delta mean, for example with a low level of incrementation and decrementation c₁ (for example equal to 1), also permitting the estimation of the background to be calculated. This low level of incrementation and decrementation corresponds to an important time constant in a recursive average calculation. For this purpose, firstly the initialisation M1₀=S₀ is carried out. For the following images, which is to say for n>0, M1ₙ₋₁ and Sₙ are compared. If M1ₙ₋₁<Sₙ, then the value of M1ₙ₋₁ is incremented such that M1ₙ=M1ₙ₋₁+c₁. If M1ₙ₋₁>Sₙ, then the value of M1ₙ₋₁ is decremented such that M1ₙ=M1ₙ₋₁−c₁.

With respect to a recursive type average, a sigma-delta type mean value has the advantage of not directly depending on the amplitude of the variations of the signal for which the mean is calculated.

In parallel to the calculation of this first mean M1ₙ, of the recursive or sigma-delta type, calculation means 104 calculate a second recursive average M2ₙ, with a low weighting coefficient 1/N₂, of the signal Sₙ. This provides:

$$M {2}_{n} = M {2}_{n - 1} - \frac{1}{{N}_{2}} M {2}_{n - 1} + \frac{1}{{N}_{2}} {S}_{n}$$

By choosing the low weighting coefficient 1/N₂, for example equal to 1/2², a filtering of the high frequency parasite elements (for example moving leaves of trees or falling rain or snow) is realized. The weighting coefficient 1/N₂ is chosen in function of the amplitude and the frequency of the variations of the captured signal Sₙ.

Then the signal Δₙ=|M1ₙ−M2ₙ| is calculated using a subtractor 106 and absolute value calculation means 108.

The device 100 also comprises means 110 of calculating a third mean M3ₙ, for example recursive with an important weighting coefficient 1/N₃, of the signal Δₙ. This third recursive mean M3ₙ is obtained using the following calculation:

$$M {3}_{n} = M {3}_{n - 1} - \frac{1}{{N}_{3}} M {3}_{n - 1} + \frac{1}{{N}_{3}} {Δ}_{n}$$

The weighting coefficient 1/N₃ is chosen in function of the amplitude and the frequency of the variations of the captured signal Sₙ. For example N₃=2⁶. The value of the operating frequency of the movement detection device also intervenes in the choice of the value of the weighting coefficient 1/N₃.

In one variant, the third mean M3ₙ may not be a recursive average, but a sigma-delta mean, for example with a constant incrementation and decrementation level c₃ (for example equal to 1). For this purpose, firstly the initialisation M3₀=Δ₀ is made. For the following images, which is to say for n>0, M3ₙ₋₁ and Δₙ are compared. If M3ₙ₋₁<Δₙ, then the value of M3ₙ₋₁ is incremented such that M3ₙ=M3ₙ₋₁+c₃. If M3ₙ₋₁>Δₙ, then the value of M3ₙ₋₁ is decremented such that M3ₙ=M3ₙ₋₁−c₃.

Finally, to determine the presence or absence of movements in the captured image n, the device 100 comprises a comparator 114 which makes a comparison of the signal Δₙ and the product of the third mean M3ₙ by an amplification constant k obtained at the output of a multiplier 112. The value of k is chosen in function of the operating frequency of the image capture device capturing the images processed. For example, k may have a value approximately between 1.2 and 4, or for example approximately between 1.5 and 2.5 for an image capture device operating at 25 Hz. If Δₙ>k.M3ₙ, this means that a movement has been detected in the captured images.

In one variant, M3ₙ may corresponds to the mean of the product of the signal Δₙ and the amplification constant k. In the case of a recursive third mean M3ₙ, M3ₙ may be obtained using the following calculation:

$$M {3}_{n} = M {3}_{n - 1} - \frac{1}{{N}_{3}} M {3}_{n - 1} + \frac{1}{{N}_{3}} k \cdot {Δ}_{n}$$

In the case of a sigma-delta third mean M3ₙ, the initialisation M3₀=k.Δ₀ is first made. For the following images, which is to say for n>0, M3ₙ₋₁ and k.Δₙ are compared. If M3ₙ₋₁<k.Δₙ, then the value of M3ₙ₋₁ is incremented such that M3ₙ=M3ₙ₋₁+c₃. If M3ₙ₋₁>k.Δₙ, then the value of M3ₙ₋₁ is decremented such that M3ₙ=M3ₙ₋₁−c₃. Finally, when M3ₙ is the mean of k.Δₙ, the comparator 114 makes a comparison of the signal Δₙ and the third mean M3ₙ. If Δₙ>M3ₙ, this means that a movement has been detected in the captured images.

On FIG. 2, this variant wherein M3ₙ is the mean of k.Δn corresponds to an emplacement of the multiplier 112 between the means of calculating 110 and the absolute value calculation means 108, the multiplier 112 receiving on its inputs the signals Δₙ and k, and outputting the signal k.Δₙ on the input of the means of calculating 110.

This method is based on the generation of two adaptive means, which is to say a first recursive or sigma-delta average and a second recursive average, each with their own weighting coefficients 1/N₁ (or c₁ in the case of a first sigma-delta type mean) and 1/N₂, respectively estimating the background and filtering the high frequency parasite movements. The thresholding of the variations detected is therefore adaptive as amplification is made with the third mean M3ₙ of the absolute difference of the two previous first means M1ₙ and M2ₙ.

In general, the incrementation and decrementation values c₁ and/or c₃ and/or the weighting coefficients 1/N1, 1/N₂ and 1/N₃ used in the means calculations are adapted in function of the pixel resolution of the captured images, which is to say the number of levels of grey onto which the processed signal is encoded, as well as the operating frequency of the movement detection device 100.

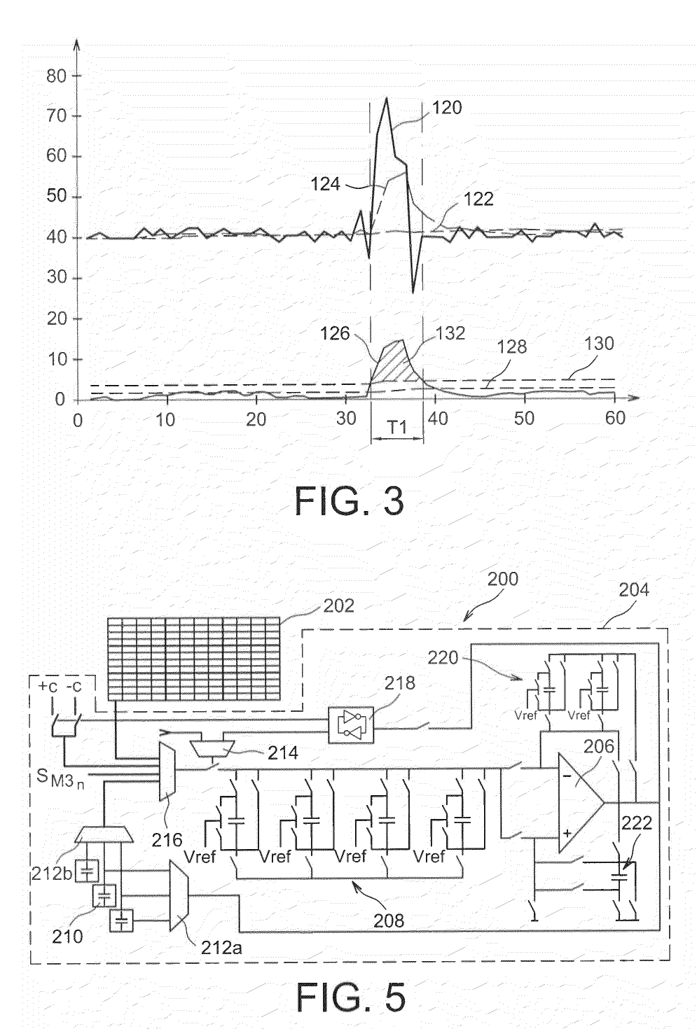

FIG. 3 shows an example of a signal Sₙ from several images captured by a pixel matrix as well as the different signals calculated during an adaptive double filtering movement detection method previously described.

In this FIG. 3, the x axis shows the evolution of the signals, graduated in the number of captured images, and the y axis shows the value of these signals graduated in the levels of grey. The curve 120 shows the signal Sₙ obtained at the output of a pixel or a macropixel. It is this signal that is sent to the input of the device 100. The curve 122 shows the first mean M1ₙ, in this case recursive, obtained at the output of the calculation means 102. This first mean M1ₙ shows the background of the image captured, which is to say the fixed element(s) captured by the pixel or the group of pixels. In FIG. 3, it can be seen that this first mean M1ₙ varies very little, which effectively corresponds to the value of the fixed elements captured. The curve 124 shows the second mean M2ₙ obtained at the output of the calculation means 104. It may be seen in FIG. 3 that this second mean M2ₙ follows the most significant variations of the output signal Sₙ according to the curve 120, thus creating an estimation of the variations, which is to say of the moving elements in the captured images. Finally, the curves 126, 128 and 130 respectively show the signals Δₙ, M3ₙ and k.M3ₙ. In this embodiment, the amplification constant k is equal to 2. In FIG. 3, it may be seen that the cross hatched part 132 corresponds to a period of time T1 during which Δₙ>k.M3ₙ, which is to say during which a movement is detected. It may be seen in this FIG. 3 that a movement is detected during the time period T1 during which the signal of the curve 2 varies the most, which is to say by capturing an important movement. Consequently, by correctly choosing the value of the weighting coefficient for the calculation of the second mean M2ₙ, the high frequency parasite movements corresponding to the low variations recorded by the image capture device are not considered as detected movements.

It is possible to impose a minimum threshold value S_{M3n} below which this mean value M3ₙ is not allowed to drop. For example, in this embodiment, the value of S_{M3n} may be equal to about 1/50×the dynamic of the signal Sₙ.

FIG. 4 shows results obtained by the use of a sigma-delta algorithm movement detection according to the prior art (image on the left) and movement detection using a double adaptive filtering movement detection method as previously described (image on the right). In these two images, the light zones show the moving objects detected. In the image on the left, it can be seen that the sigma-delta algorithm has allowed the vehicles in movement to be detected, but has also considered precipitations (falling snow in this case) as movements to be detected. In the image on the right, it can be seen that the double adaptive filtering movement detection method has indeed considered the moving vehicles and has correctly considered the falling snow as high frequency parasite movements that are not to be taken into account.

One example of an image capture device 200, or optical imaging device, permitting a double adaptive filtering movement detection method previously described to be implemented is shown in FIG. 5.

The image capture device 200 comprises pixel matrix 202 and a movement detection device 204. Each pixel of the matrix 202 is here formed by a photodiode and addressing and reading transistors. The double adaptive filtering movement detection method previously described may be applied to the signal Sₙ supplied by a pixel, by connecting a movement detection device similar to the device 204 to each column of pixels of the matrix 202. It is also possible that the movement detection method is applied to a signal Sₙ corresponding to the signals supplied by several pixels, for example the mean of these signals. Consequently, by considering the macropixels, it is possible to operate the image capture device 200 in low resolution zones, and only to detail these zones by using a double adaptive filtering movement detection method for each pixel of a macropixel when a movement is detected on this macropixel. It is therefore possible to reduce the number of movement detection devices 204 used in the image capture device 200 by only using a single movement detection device 204 per column of macropixels. A macropixel may for example be a square of 12×12 pixels, or any other value, for example 4×4 pixels as in FIG. 5. The values of each macropixel of the matrix 202 are read line by line.

The movement detection devices 204 shown in FIG. 5 comprises a comparator 206, for example an operational amplifier (or transconductance amplifier), a plurality of switched capacities 208, analogue memory registers 210 (three memory registers 210 are shown in FIG. 5 but the movement detection device 204 may comprise a different number of memory registers adapted to the number of values to be stored while the movement detection method is in use), an address demultiplexer 212a, an address multiplexer 212b, a multiplexer 214 for controlling the writing in the switched capacities 208, a multiplexer 216 supplying the values to be written in the switched capacities 208, a SRAM memory 218, capacitors 220 designed to obtain different values of a multiplication coefficient k and a capacitor 222.

The operation of the movement detection device 204 will now be described in relation to the implementation of the movement detection method previously described.

In the case of a first mean M1ₙ of the recursive type, the value of the signal Mₙ₋₁ stored in one of the memory registers 210 is supplied to the input of the multiplexer 216, by means of the address multiplexer 212b. When n=0, M₋₁=0. The first recursive mean M1ₙ is then calculated. For this purpose, the signal Mₙ₋₁ is sent to the terminals of a first switched capacity 208 whose value C₃ is equal to (N₁−1)/N₁. The value of the signal Mₙ₋₁ is stored at the terminals of this capacity.

The signal Sₙ supplied by the first macropixel of the matrix 202 is then supplied to the input of the multiplexer 216. The value of the signal Sₙ is stored at the terminals of a second switched capacity whose value C₄ is equal to 1/N₁.

By connecting in parallel the two switched capacities of values C₃ and C₄, the signal

$$M {1}_{n} = M {1}_{n - 1} - \frac{1}{{N}_{1}} M {1}_{n - 1} + \frac{1}{{N}_{1}} {S}_{n}$$

is obtained at the terminals of these capacities.

It is also possible that the mean M1ₙ is a sigma-delta mean. For this purpose, the initialisation M1₀=S₀ is carried out by storing the value of the signal S₀ in one of the memory registers 210. For the following images, M1ₙ₋₁ and Sₙ are compared by applying one of the two signals to the positive input of the comparator 206 by means of the capacitor 222 in which this signal is stored, and by applying the other of the two signals to the negative input of the comparator 206. The result obtained at the output of the comparator 206 the permits one of the values +c₁ or −c₁ applied to the input of the multiplexer 216 (+c and −c in FIG. 5) to be selected. If M1ₙ₋₁<Sₙ, then the value of M1ₙ₋₁ is incremented such that M1ₙ=M1ₙ₋₁+c₁. If M1ₙ₋₁>Sₙ, then the value of M1ₙ₋₁ is decremented such that M1ₙ=M1ₙ₋₁−c₁. In this embodiment, c₁=1. The addition operation of ±c₁ à M1ₙ₋₁ is carried out by means of the capacities 208 by storing at the terminals of two of these capacities the ±c₁ and M1ₙ₋₁ values, and by connecting these capacities in series so as to carry out an addition.

Whether the mean M1ₙ is of the recursive or sigma-delta type, its value is stored in one of the memory registers 210. In this embodiment, the movement detection device 204 comprises three memory registers 210 designed to store three different means M1ₙ, M2ₙ and M3ₙ.

In a similar manner to the calculation of the first mean M1ₙ when the latter is of the recursive type, the calculation of the second recursive mean M2ₙ is carried out. This calculation is made by using another of the memory registers 210 and two other switched capacities of the set-up 208 with values C₁ and C₂, respectively of values (N₂−1)/N₂ and 1/N₂.

Then the signal Δₙ=|M1ₙ−M2ₙ| is calculated. This operation may be carried out by means of the switched capacities 208.

In a similar manner to the calculation of the first mean M1ₙ, the calculation of the third mean M3ₙ is carried out. As for the first mean M1ₙ, the third mean M3ₙ may be of the sigma-delta type or the recursive type. This calculation is implemented by the same elements of the device 204 as those used to calculate the first mean M1ₙ when M1ₙ and M3ₙ are of the same type.

A comparison is then made using the amplifier 206 of the signal Δₙ and the product of the third mean M3ₙ by an amplification constant k whose value is obtained by the ratio between one of the capacities 220 and another of the switched capacities 208, or between the signal Δₙ and the third mean M3ₙ when M3ₙ corresponds to the third mean M3ₙ of k.Δₙ. The value obtained at the output of the amplifier 206 is representative of a detection or non-detection of a movement on the macropixel considered. If Δₙ>k.M3ₙ (or Δₙ>M3ₙ when M3ₙ corresponds to the third mean M3ₙ of k.Δₙ), then it is considered that a movement has been detected on the macropixel considered.

The operation is then repeated for the following macropixels, line after line.

During the calculations of the third mean M3ₙ, a minimum threshold value may be imposed, below which this mean is not allowed to descend. This minimum threshold value S_{M3n} may be applied to the input of the multiplexer 216. When the value of this mean is below this threshold value, the value of M3ₙ is then replaced by the threshold value S_{M3n}.

When a movement is detected on the macropixel, it is possible, for an image n for which the movement detection has been carried out on macropixels, to store the values of the macropixels in the memory 218, then, on the macropixel(s) where movements are recorded, to implement the movement detection method previously described for each of the pixels of the macropixel. Consequently, the location of the movements detected may be defined precisely, without processing all of the pixels of the captured images.

It may be seen that the method may be implemented using few hardware calculation resources (an operational amplifier, several switched capacities with a clock frequency for the instructions of several tens of kHz and several multiplexers/demultiplexers) and memory resources (several analogue registers per pixel and a SRAM memory for example).

The device shown in FIG. 5 permits an analogue implementation of the movement detection method previously described. However, it is also possible to use a digital implementation of the movement detection method by connecting the pixel matrix 202 to signal digital processing means, for example a circuit of the DSP or FPGA type or a microprocessor, wherein the movement detection method is programmed.

The signals obtained at the output of the movement detection devices may be used to display an image on which the background captured forms a black background onto which the moving elements detected are shown in white, for example as shown on the image on the right in FIG. 4.

1. A movement detection method comprising at least the following steps:
the calculation of a first mean M1ₙ of a signal Sₙ designed to be supplied by at least one pixel of a pixel matrix which corresponds to an n-th captured image, in function of the value of the signal Sₙ and/or a previous value M1ₙ₋₁;
the calculation of a second mean M2ₙ of the signal Sₙ in function of a previous value M2ₙ₋₁ and/or the value of the signal Sₙ;
the calculation of a signal Δₙ=|M1ₙ−M2ₙ|;
the calculation of a third mean M3ₙ of the signal Δₙ or k.Δₙ in function of a previous value M3ₙ₋₁ and/or the value of the signal Δₙ;
the comparison of the signals Δₙ and k.M3ₙ when M3ₙ is the third mean of the signal Δₙ, wherein a movement is considered as detected when Δₙ>k.M3ₙ, or the comparison of the signals Δₙ and M3ₙ when M3ₙ is the third mean of the signal k.Δₙ, wherein a movement is considered as detected when Δₙ>M3ₙ;
where k: non-null positive real number, and
n: natural whole number.

2. The method according to claim 1, wherein the second mean M2ₙ is obtained from the following equation:
$$M {2}_{n} = M {2}_{n - 1} - \frac{1}{{N}_{2}} M {2}_{n - 1} + \frac{1}{{N}_{2}} {S}_{n} ,$$
where M2₋₁=0, and
1/N₂: non-null positive real number.

3. The method according to claim 1, wherein the first mean M1ₙ is obtained from the following equation:
$$M {1}_{n} = M {1}_{n - 1} - \frac{1}{{N}_{1}} M {1}_{n - 1} + \frac{1}{{N}_{1}} {S}_{n} ,$$
where M₋₁=0, and
1/N₁: non-null positive real number.

4. The method according to claim 1, wherein the first mean M1ₙ is obtained with at least the following calculation steps:
M1₀=S₀;
and for n>0:
M1ₙ=M1ₙ₋₁+c₁ when M1ₙ₋₁<Sₙ;
M1ₙ=M1ₙ₋₁−c₁ when M1ₙ₋₁>Sₙ;
where c₁: non-null positive real number.

5. The method according to claim 1, wherein, when M3ₙ is the third mean of the signal Δₙ, the third mean M3ₙ is obtained from the following equation:
$$M {3}_{n} = M {3}_{n - 1} - \frac{1}{{N}_{3}} M {3}_{n - 1} + \frac{1}{{N}_{3}} {Δ}_{n} ,$$
and when M3ₙ is the third mean of the signal k.Δₙ, M3ₙ is obtained from the following equation:
$$M {3}_{n} = M {3}_{n - 1} - \frac{1}{{N}_{3}} M {3}_{n - 1} + \frac{1}{{N}_{3}} k \cdot {Δ}_{n} ,$$
where M3₋₁=0, and
1/N₃: non-null positive real number.

6. The method according to claim 1, wherein, when M3ₙ is the third mean of the signal Δₙ, the third mean M3ₙ is obtained with at least the following calculation steps:
M3₀=Δ₀;
and for n>0:
M3ₙ=M3ₙ₋₁+c₃ when M3ₙ₋₁<Δₙ;
M3ₙ=M3ₙ₋₁−c₃ when M3ₙ₋₁>Δₙ;
and when M3ₙ is the third mean of the signal k.Δₙ, M3ₙ is obtained at least by the following calculation steps:
M3₀=k.Δ₀;
and for n>0:
M3ₙ=M3ₙ₋₁+c₃ when M3ₙ₋₁<k.Δₙ;
M3ₙ=M3ₙ₋₁−c₃ when M3ₙ₋₁>k.Δₙ;
where c₃: non-null positive real number.

7. The method according to claim 1, wherein the value of the third mean M3ₙ is greater than a third non-null minimum threshold value S_{M3n}.

8. The method according to claim 1, wherein the value of S_{M3n} is comprised between approximately 1/250×the dynamic of the signal Sₙ and 1/25×the dynamic of the signal Sₙ.

9. The method according to claim 1, wherein the value of k is approximately between 1.2 and 4.

10. The method according to claim 1, wherein the values of 1/N₁ and/or 1/N₂ and/or 1/N₃ are chosen such that:
période(Sₙ)/ln(1−1/N₁)⁻¹<0.5 s;
période(Sₙ)/ln(1−1/N₂)⁻¹>1 s;
période(Sₙ)/ln(1−1/N₃)⁻>1 s;
and/or the values of c₁ and/or c₃ verify the relation:
c<|dSₙ/dn|.

11. The method according to claim 1, wherein the calculation of the third mean M3ₙ is realized when Δₙ has a non-null value.

12. A movement detection device comprising at least:
means of calculating a first mean M1ₙ of a signal Sₙ designed to be supplied by at least one pixel of a pixel matrix and corresponding to an n-th captured image, in function of the value of the signal Sₙ and/or a previous value M1ₙ₋₁;
means of calculating a second mean M2ₙ of the signal Sₙ in function of a previous value M2ₙ₋₁ and/or the value of the signal Sₙ;
means of calculating a signal Δₙ=|M1ₙ−M2ₙ|;
means of calculating a third mean M3ₙ of the signal Δₙ or k.Δₙ, in function of a previous values M3ₙ₋₁ and/or the value of the signal Δₙ;
means of comparing the signals Δₙ and k.M3ₙ when M3ₙ is the third mean of the signal Δₙ, wherein a movement is considered as detected when Δₙ>k.M3ₙ, or means of comparing the signals Δₙ and M3ₙ when M3ₙ is the third mean of the signal k.Δₙ, wherein a movement is considered as detected when Δₙ>M3ₙ;
where k: non-null positive real number, and
n: natural whole number.

13. The device according to claim 12, wherein the means of calculating the second mean M2ₙ carry out at least the following operation:
$$M {2}_{n} = M {2}_{n - 1} - \frac{1}{{N}_{2}} M {2}_{n - 1} + \frac{1}{{N}_{2}} {S}_{n} ,$$
where M2₋₁=0, and
1/N₂: non-null positive real number.

14. The device according to claim 12, wherein the means of calculating the first mean M1ₙ carry out at least the following operation:
$$M {1}_{n} = M {1}_{n - 1} - \frac{1}{{N}_{1}} M {1}_{n - 1} + \frac{1}{{N}_{1}} {S}_{n} ,$$
where M1₋₁=0, and
1/N₁: non-null positive real number.

15. The device according to claim 12, wherein the means of calculating the first mean M1ₙ at least comprise:
means of initialising the value of M1₀ to the value of S₀;
means of comparing the value of the signal M1ₙ₋₁ and the value of the signal Sₙ;
means of incrementing and decrementing the value of M1ₙ by a constant c, where c: non-null positive real number.

16. The device according to claim 12, wherein, when M3ₙ is the third mean of the signal Δₙ, the means of calculating the third mean M3ₙ carry out at least the following operation:
$$M {3}_{n} = M {3}_{n - 1} - \frac{1}{{N}_{3}} M {3}_{n - 1} + \frac{1}{{N}_{3}} {Δ}_{n} ,$$
and when M3ₙ is the third mean of the signal k.Δₙ, the means of calculating the third mean M3ₙ carry out at least the following operation:
$$M {3}_{n} = M {3}_{n - 1} - \frac{1}{{N}_{3}} M {3}_{n - 1} + \frac{1}{{N}_{3}} k \cdot {Δ}_{n} ,$$
where M3₋₁=0, and
1/N₃: non-null positive real number.

17. The device according to claim 12, wherein, when M3ₙ is the third mean of the signal Δₙ, the means of calculating the third mean M3ₙ at least comprise:
means of initialising the value of M3₀ to the value of Δ₀;
means of comparing the value of the signal M3ₙ₋₁ and the value of the signal Δₙ;
means of incrementing/decrementing the value of M3ₙ by a constant c₃, where c₃: non-null positive real number;
and when M3ₙ is the third mean of the signal k.Δₙ, means of calculating the third mean M3ₙ comprise at least:
means of initialising the value of M3₀ to the value of k.Δ₀;
means of comparing the value of the signal M3ₙ₋₁ and the value of the signal k.Δₙ;
means of incrementing and decrementing the value of M3ₙ by a constant c₃, where c₃: non-null positive real number.

18. An image capture device comprising at least one pixel matrix and one movement detection device according to claim 12.
